(19) United States
(12) Patent Application Publication
(10) Pub. No.: US 2023/0170463 A1
(43) Pub. Date: Jun. 1, 2023

(54) TRANSPORT DEVICE WITH REDUCED CREASING FOR BATTERY FOILS

(71) Applicant: BATTRION AG, Duebendorf (CH)

(72) Inventor: Martin EBNER, Kuesnacht (CH)

(73) Assignee: BATTRION AG, Duebendorf (CH)

(21) Appl. No.: 18/059,467

(22) Filed: Nov. 29, 2022

(30) Foreign Application Priority Data
Dec. 1, 2021 (DE) 10 2021 131 666.9

(51) Int. Cl. H01M 4/1393; H01M 4/04; H01M 4/133

(52) U.S. Cl. CPC H01M 4/1393; H01M 4/0404; H01M 4/0409; H01M 4/133; H01M 2004/029

(57) ABSTRACT

Proposed is a transport device for transporting a carrier in the form of a foil for producing electrodes for energy accumulators, in particular electrodes for lithium-ion batteries, having at least two rollers on which the carrier is able to be borne, and of which at least one roller is provided with a drive so as to transport the carrier from roller to roller. Provided for reducing creasing is a drive device for generating an additional force that facilitates transport, wherein the drive device for generating an alternating magnetic field has an alternating field generator which generates a temporally alternating magnetic field, the magnetic field being oriented such that, in addition to the effect of force in the transport direction, an effect of force perpendicular to the transport direction is initiated in the plane of the carrier.

This application claims the benefit under 35 USC § 119(a)-(d) of German Application No. 10 2021 131 666.9 filed Dec. 1, 2021, the entirety of which is incorporated herein by reference.

### FIELD OF THE INVENTION

The present invention relates to a transport device for transporting a carrier in the form of a foil for producing electrodes for energy accumulators, in particular, electrodes for lithium-ion batteries.

### BACKGROUND OF THE INVENTION

In the production of batteries according to the prior art, ribbon-shaped carriers are typically used as the basis for electrodes. These carriers are provided with a coating which contains, for example, graphite particles that are oriented in a temporally or locationally variable magnetic field. Besides the graphite particles, other materials such as, for example, silicon particles or silicon oxide particles, mixtures of different types of graphite, as well as binders, conductivity additives and surface modifications may also be included. In the further course of the manufacturing process, the carrier webs are then, inter alia, compressed and cut. It is, however, frequently observed in the production electrodes that the web-shaped carrier material is subjected to creasing, this potentially compromising the quality of the product and compromising or rendering impossible the further processing into lithium ion batteries.

### SUMMARY OF THE INVENTION

As opposed thereto, it is an object of the present invention to provide a transport device in which creasing in the carrier material can be reduced.

The transport device according to the present invention provides that the web-shaped carrier is conveyed by means of a roller-to-roller method, i.e. the carrier is moved from roller to roller. At least one of the rollers is equipped with a drive and in turn, by a rotating movement, moves the carrier along the longitudinal direction thereof in a transport direction.

It has been demonstrated in conventional processes according to the prior art that there is a certain tendency toward the carrier being potentially subjected to creasing. In the course of the present invention, it has been established that this creasing is initiated by mechanical forces which act on the carrier and may cause tension in the web.

The tension during the transport process per se may contribute to the creasing, on the one hand. This effect is particularly intense in long carrier webs and at high transport speeds at which great forces, or accelerations, respectively, are to be expected.

On the other hand, an orienting device by way of which the particles in a coating on the carrier can be oriented in a magnetic field that is variable in terms of time and location, also contributes toward these mechanical tension effects. The carrier comprises an electrically conducting material. The carrier is typically composed of a copper foil. The magnetic fields, which are variable in terms of time and location, respectively, as a result of magnetic induction cause the flow of eddy currents, the magnetic fields of the latter in turn interacting with the outer magnetic fields. Lorentz forces, which are transmitted to the carrier, act on the moving charge carriers. This leads to an effect of force counter to the transport movement, i.e. to a braking force. The braking force causes distortions in the material, and creases may form. Moreover, the orienting process can lead to an anisotropic drying procedure being formed, in which the coating has a higher shrinkage in the transverse direction than in the thickness or in the longitudinal direction, for example. The present invention can counteract this.

A core concept of the present invention now lies in permitting forces by way of which these undesirable forces can be equalized to act on the carrier. However, the present invention goes even beyond this, because stretching of the carrier transversely to the transport direction is advantageous for effectively reducing creasing.

According to the present invention, an additional drive device is provided for exerting this additional force. This drive device advantageously uses an alternating field generator which generates an alternating magnetic field. Because the carrier is situated in an outer magnetic field, eddy currents in the electrically conducting carrier can also be generated by this temporally variable alternating field such that a Lorentz force acts on the charges that flow in the carrier as a result of the eddy currents.

However, the drive device, or the alternating field generator, respectively, is configured such that, besides an effect of force in the transport direction, an effect of force perpendicular to the transport direction in the plane of the carrier is also additionally initiated. This force, which acts perpendicularly to the transport direction in the carrier plane, enables creasing to be effectively reduced or prevented.

The present invention moreover makes it possible that this additional force is generated on the carrier without the carrier being directly contacted, i.e. the additional drive device enables the forces to act on the carrier in a non-contacting manner. A non-contacting transmission of force prevents damage to a not yet fully cured coating as a result of mechanical pressure being applied through contact.

Web tensions that lead to creasing can be determined by various factors, for example, by tensile forces on the carrier at a high transport speed and/or a large length of the carrier, or else by braking forces which additionally act on the carrier as a result of magnetic induction by an orienting device. Creasing is typically associated with bulging of the carrier. The forces which act on the carrier clamped in the transport device are not distributed in a homogeneous but an anisotropic manner overall across the carrier surface. Typical bulging as a result of the web tension is a barrel-shaped bulge along the longitudinal extent of the carrier. Therefore, the drive device, or the alternating field generator thereof, respectively, advantageously generates forces which as transverse forces act on at least two different points on the carrier. The drive device thus not only ensures that forces such as, for example, braking forces which act along the longitudinal extent of the carrier, are reduced but also that creasing is reduced by transversely stretching the carrier.

Creasing can be particularly advantageously reduced when transverse forces act on the carrier on the lateral peripheries of the carrier, the transverse forces being greater than the forces acting in the center of the carrier (in terms of the transverse extent of the latter). In this way, a braking force that contributes toward an increase in the web tension can be reduced, for example, this contributing toward reducing creasing. This reducing of creasing is however also facilitated by stretching transversely to the transport direction.

In one embodiment of the present invention, the alternating field generator can be integrated in a space-saving manner in a roller and disposed along the transport section, like the rollers provided for bearing the web, for example, such that the point along the transport section at which the forces act on the transport path can be substantially freely chosen. This additional drive device, or the alternating field generator, respectively, can also be integrated in one of the bearing rollers, which are provided anyway, or in an additional roller.

The carrier web, at least in portions, can also be borne in a floating manner and does not mandatorily have to be in contact with all rollers.

In order to generate a temporally variable magnetic field, the alternating field generator integrated in the roller can have permanent magnets that are disposed on the circumference of the roller. When these permanent magnets are oriented in a mutually dissimilar manner in relation to the surface of the roller, a rotation of the roller thus has the effect that, in terms of the carrier, there is a temporally variable field. The permanent magnets can be oriented in a Halbach array, for example, thus radially outward in terms of the roller, then tangential in the rotation direction, radially inward, tangential counter to the rotation direction, and radially outward again. A multipolar arrangement having fields which in an alternating manner are oriented inward or outward is also conceivable.

In order to be able to generate transverse forces, the permanent magnets can however also be disposed so as to again be tilted in terms of the rotation axis of the roller. In this instance, the Lorentz force does not act exactly parallel to the transport direction but, owing to the tilting of the magnetic field, or the changed direction of movement of the charge carriers, respectively, includes a transverse component. By virtue of the creasing to be expected in conventional transport devices, it is advantageous for the carrier in the peripheral regions to be impinged with transverse forces, while the undesirable braking force in the center of the carrier is primarily reduced.

The permanent magnets, at the positions thereof on the circumference of the roller, can be tilted about the respective axle on which they are borne and which runs parallel to the rotation axis of the roller. In one advantageous embodiment of the present invention, the permanent magnets may be more intensely tilted the closer the permanent magnets lie to the periphery of the roller. If an axis in the transport direction is drawn so as to be centric through the roller, thus perpendicular to the rotation axis, the permanent magnets in one refinement of the present invention are disposed so as to be symmetrical to this axis such that the carrier can be impinged with forces in a manner mirror-symmetrical in terms of this axis, creasing thus being reduced even more effectively. The envelope region of the magnetic roller, along the circumference thereof, perpendicular to the rotation axis can be divided into regions in which the magnets are in each case uniformly tilted.

A substantial advantage of the magnetic roller lies in that the latter requires a drive (for example a motor with a timing belt) and thus can fundamentally operate with a minor power requirement. Therefore, a high level of heat generation by this component is also not to be expected. Another option lies in using the stator of a linear motor as the alternating field generator. Since no rotating parts are required, frictional effects also do not arise here. For example, the stator is composed of an iron core, or, for example, a laminated sheet package, which serves for suppressing eddy currents. Individual grooves, in which at least three coils that are passed through by a phase-delayed (3-phase) alternating current are situated, are recessed along the transport direction in the core.

The coils, or the grooves, respectively, can be disposed such that transverse forces again arise in the peripheral regions of the carrier, while the driving forces can act parallel to the transport direction and counter to the undesirable braking forces in the center. To this end, coils can be disposed in the form of a matrix in the plane that runs parallel to the carrier plane, for example. The stator of the linear motor also operates in a non-contacting manner and does not contact the carrier. The carrier can be driven, or accelerated, by the stator like a rotor.

### BRIEF DESCRIPTION OF THE INVENTION

Exemplary embodiments of the present invention are illustrated in the drawings and will be explained in more detail below with further details and advantages being set forth.

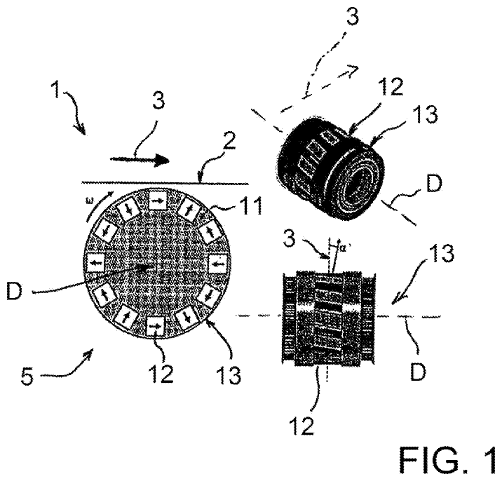

FIG. 1 shows a schematic illustration of a transport device according to the present invention, having a magnetic roller;

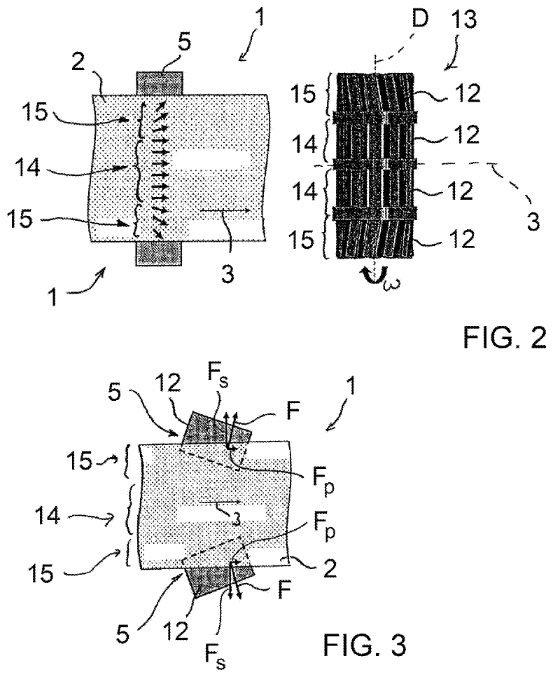

FIG. 2 shows a schematic illustration of a transport device according to the present invention, having a mirror-symmetrical disposal of the permanent magnets;

FIG. 3 shows a schematic illustration of the distribution of forces; and

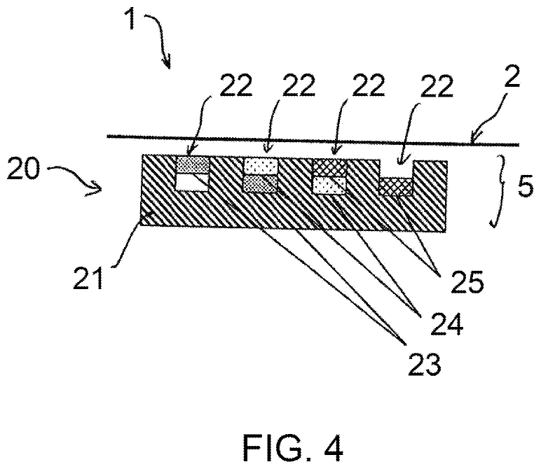

FIG. 4 shows a schematic illustration of a transport device, having a stator of a linear motor.

### DETAILED DESCRIPTION OF THE INVENTION

FIG. 1 shows a schematic of a transport device 1 having a carrier 2 which in the transport direction 3 is transported in a roller-to-roller process. The carrier 2 is coated with a layer which contains graphite particles. These graphite particles are subsequently oriented in a magnetic field which is variable in terms of time and/or location. This orienting device is also not illustrated in FIG. 1. As a result of magnetic induction as a consequence of the changing magnetic field, eddy currents are induced in the electrically conducting carrier (a copper foil, for example). These eddy currents generate magnetic fields which interact with the outer magnetic fields and cause a braking force. These braking forces can represent the cause for web warping.

Moreover, web tensions that act on the carrier can also be created in that the carrier web is very long and/or high transport speeds occur.

In order to counteract creasing as a result of these web tensions, an additional drive device 5, which is configured as a magnetic roller 13, is provided. Permanent magnets 12 are disposed along the circumference in a roller 11, the permanent magnets 12 in a Halbach array here being disposed in an alternating manner parallel to the surface of the roller 11 in the rotation direction (clockwise in FIG. 1), radially outward, parallel to the surface counter to the rotation direction, then radially inward, etc.

The magnetic roller 13 below the carrier 2 rotates clockwise at the rotating speed a), so as to generate a temporally variable magnetic field. To this end, the roller 11 per se is mounted on a static shaft and with roller bearings.

To be seen in FIG. 1 is also a lateral illustration of the magnetic roller 13, when viewed perpendicularly to the rotation axis D, and a perspective illustration of the magnetic roller 13, wherein the permanent magnets 12 along the circumference of the roller 11 are tilted by the angle α in relation to the transport direction 3, or in relation to an orientation perpendicular to the rotation axis D, respectively, so as to by magnetic induction generate forces that do not run parallel to the transport direction 3 but also comprise transverse forces in order to be able to avoid creasing even more effectively.

Creasing as a result of web tensions can typically be associated with bulging, the latter running toward the sides about an axis along the transport direction 3. FIG. 2 shows a transport device 1, wherein the carrier 2 to be transported is shown in a plan view from above. The additional drive device 5 is disposed below the carrier 2. The drive device 5 in the same view is shown once again beside the latter. The additional drive device 5 comprises a magnetic roller 13, permanent magnets 12 being disposed on the surface of the magnetic roller 13. The roller 13 rotates about the rotation axis D at the rotating speed a), so as to generate a temporally variable magnetic field. The envelope surface is divided into four regions, wherein the inner regions 14 show a disposal of the permanent magnets 12 in the rotation direction D. The permanent magnets 12 in the peripheral regions 15 are tilted in relation to the rotation axis D. The disposal of the permanent magnets 12 runs so as to be mirror-symmetrical in terms of an axis 3, the latter here coinciding with the transport direction. The drive device 5 is disposed below the carrier 2 such that the carrier in terms of the transverse extent thereof is completely engaged by the magnetic roller 13. The carrier 2 in the peripheral regions thereof is thereafter predominantly penetrated by the field lines of the magnetic fields of the permanent magnets 12 from the regions 15.

In this way, the direction of force in the peripheral regions 15 of the carrier 2 also deviates from the direction of force in the center 14 of the carrier 2. The effect of force in the center 14 is oriented so as to be parallel to the transport direction 3; the force acting on the carrier 2 in the peripheral regions 15 includes a component that in the carrier plane points away from the carrier 2, thus a transverse component.

FIG. 3 shows the illustration of the force vectors in the peripheral regions 15. The transport device 1 is again shown schematically when viewed toward the plane in which the carrier 2 is transported in the transport direction 3. The oblique position of the permanent magnets 12 of the drive device 5 is only schematically indicated. As a result of magnetic induction as a consequence of the magnetic fields being temporally changed by the rotation of the roller 13, eddy currents are created in the carrier 2. Lorentz forces act on the moving charges in the outer magnetic field, the Lorentz forces reducing undesirable braking forces parallel to the transport direction but also being able to counteract creasing all the more because transverse forces act on the peripheries.

The Lorentz forces substantially weaken the braking forces in the center 14. The Lorentz forces F are more intensely oriented outward in the peripheral regions 15. The acting force component Fₚ in the transport direction 3 is smaller than the transverse force Fₛ acting perpendicularly thereto. The closer to the periphery of the carrier 2, the greater the transverse forces that by lateral pulling can reduce bulging of the carrier 2, while the web tension in the center 15 of the carrier 2 is substantially reduced by reducing the braking forces.

The drive device 5 is preferably configured for not contacting the carrier 2, thus for operating in a non-contacting manner, so as not to damage the coating of the carrier 2, or disturb the orientation of the particles contained in the latter, respectively.

It is illustrated in FIG. 4 how such a drive device 5 can furthermore be implemented. For example, in order to exert high accelerations on the carrier 2 during the linear movement of the latter, the stator 20 of a linear motor can also be used as the additional drive device 5. Grooves 22, which in each case accommodate the coils 23, 24, 25, are incorporated in the iron core 21. The coils 23, 24, 25 are passed through by a phase-delayed 3-phase alternating current. The arrangement with a linear motor typically requires a high power consumption and produces a lot of heat.

In order to permit the transverse-force components in the peripheral regions 15 of the carrier 2 to become effective with respect to a parallel orientation in the center 14, the coils in the stator 20 are disposed in the form of a matrix in a plane parallel to the carrier plane, and are correspondingly tilted in the peripheral regions 15.

### LIST OF REFERENCE SIGNS

1 Transport device
2 Carrier
3 Transport direction
5 Additional drive device
11 Roller
12 Permanent magnets
13 Magnetic roller
14 Central region
15 Peripheral region
20 Stator of a linear motor
21 Iron core
22 Groove
23, 24, 25 Coils
D Rotation axis
F Force
Fₚ Force component parallel to the transport direction
Fₛ Force component perpendicular to the transport direction
ω Rotating speed
α Angle

1. A transport device for transporting a carrier in the form of a foil for producing electrodes for energy accumulators, having a least two rollers on which the carrier is able to be borne, and of which at least one of the rollers is provided with a drive so as to, by rotating the driven roller, move the carrier along the longitudinal extent thereof in a transport direction and to transport the carrier from roller to roller, further comprising a drive device for generating an alternating magnetic field that has an alternating field generator which, for generating eddy currents in the carrier, generates a temporally alternating magnetic field in order to exert a Lorentz force on the charges flowing in the carrier as a result of the eddy currents, said magnetic field being oriented such that, in addition to the effect of force in the transport direction, an effect of force perpendicular to the transport direction is initiated in the plane of the carrier.

2. The transport device according to claim 1, wherein the alternating field generator is disposed such that the latter is not in contact with the carrier during transport.

3. The transport device according to claim 1, wherein the drive device and/or the alternating field generator are/is configured for permitting forces to act on the carrier on at least two different points which lie along the transverse extent of said carrier perpendicular to the transport direction, said forces pointing in two mutually dissimilar directions.

4. The transport device according to claim 1, wherein the drive device and/or the alternating field generator are/is configured for permitting transverse forces to act on the carrier on the lateral peripheries of the carrier, said transverse forces in the carrier plane being directed perpendicularly to the transport direction and being greater than the forces acting in the center of the carrier and in the transverse extent in terms of the latter.

5. The transport device according to claim 1, wherein the alternating field generator is integrated in one of the rollers.

6. The transport device according to claim 1, wherein the alternating field generator is configured as a rotor, at least two permanent magnets being disposed along the circumference of said rotor.

7. The transport device according to claim 6, wherein the permanent magnets are disposed in a Halbach array along the circumference such that the fields in the interior of the permanent magnets are in each case oriented so as to be tangential or radial in relation to the path of rotation in the rotation plane.

8. The transport device according to claim 6, wherein at least one of the permanent magnets is in each case tilted about an axis running radially in relation to the rotation axis of the rotor.

9. The transport device according to claim 6, wherein the permanent magnets in the peripheral region of the rotor that is situated on the lateral region of the carrier are more intensely tilted about an axis running radially in relation to the rotation axis of the rotor than in the central region of the rotor.

10. The transport device according to claim 1, wherein the drive device and/or the alternating field generator are/is configured for permitting forces to act on the carrier, said forces running so as to be mirror-symmetrical in terms of a symmetry axis which is parallel to the transport direction and through which the center of the carrier runs.

11. The transport device according to claim 1, wherein the alternating field generator is configured as a stator of a linear motor which is disposed relative to the transport section of the carrier such that the carrier is driven as a rotor.

12. The transport device according to claim 11, wherein the stator of the linear motor has at least three coils which are disposed along the transport section of the carrier and through which a mutually phase-delayed alternating current flows.

13. The transport device according to claim 12, wherein the coils are disposed in the form of a matrix so as to be parallel to the carrier plane.

14. The transport device according to claim 1, wherein an orienting device is provided for orienting graphite particles as an electrode for lithium-ion batteries, in a coating with which the carrier is provided, said orienting device for orienting generating a magnetic field that is variable in terms of time and/or location.

15. The transport device according to claim 14, wherein the orienting device is configured for generating eddy currents in the carrier plane in the carrier, the preferred directions of said eddy currents in the center of the carrier, running transversely to the transport direction on the periphery of the carrier running in and/or obliquely to the transport direction.
